(19) United States
(12) Patent Application Publication
(10) Pub. No.: US 2026/0261038 A1
(43) Pub. Date: Sep. 3, 2026

(54) LIGHTING UNIT COMPONENT WITH INTEGRATED WAVEGUIDE ANTENNA

(71) Applicant: Valeo Schalter und Sensoren GmbH, Bietigheim-Bissingen (DE)

(72) Inventors: Milan Kvicera, Prague (CZ); Gunnar Vikberg, Creteil (FR); Ernst Weissbrodt, Bietigheim-Bissingen (DE); Uwe Papziner, Bietigheim-Bissingen (DE); Frank Sickinger, Bietigheim-Bissingen (DE); Aleksander Godic, Bietigheim-Bissingen (DE); Ondrej Stejskal, Prague (CZ); Michal Mandlik, Prague (CZ); Lukas Carek, Bietigheim-Bissingen (DE)

(73) Assignee: Valeo Schalter und Sensoren GmbH, Bietigheim-Bissingen (DE)

(21) Appl. No.: 19/489,167

(22) PCT Filed: May 14, 2024
(86) PCT No.: PCT/EP2024/063136

§ 371 Date: Dec. 1, 2025

(30) Foreign Application Priority Data
Jun. 1, 2023 (DE) 10 2023 114 378.6

(51) Int. Cl. H01Q 1/32; B60Q 1/00; B60Q 1/04; B60Q 1/30; G01S 7/02

(52) U.S. Cl. CPC H01Q 1/3233; B60Q 1/0023; B60Q 1/04; B60Q 1/30; G01S 7/027

(57) ABSTRACT

Disclosed is a method for producing a component of a lighting unit for a vehicle. A metallized plastic waveguide antenna element for a radar sensor of the vehicle is integrated into the component. The method includes providing the component of the lighting unit made from plastic and providing a portion of the metallized plastic waveguide antenna element. A portion of a frontside of the component is metallicized, and the portion of the frontside of the component comprises the portion of the metallized plastic waveguide antenna element as an integral part.

### FIELD OF THE INVENTION

The invention relates to the field of waveguide antennas. More precisely, the invention relates to a method for producing a component of a lighting unit for a vehicle with a waveguide antenna element.

### BACKGROUND

Waveguide antennas are used in various fields, e.g., in radar sensors or communication systems. They have different desirable properties, such as less standard deviation in their performance, i.e., gain and phase, compared to typical microstrip antennas, as well as being flatter and thus easier arrangeable within devices than typical horn antennas.

US 2020/0101889 A1 describes an in-vehicle light apparatus for monitoring a region in a first direction outside a vehicle, including: a lamp unit including a light source and a reflector; a radar unit including a circuit board disposed such that a board surface extends substantially along the horizontal direction on a lower side or an upper side of the lamp unit and a plurality of antenna elements disposed in the board surface of the circuit board to transmit an electromagnetic wave in the first direction.

It is an objective to provide for a method for producing a component of a lighting unit for a vehicle, for a component for a lighting unit of a vehicle, and for a lighting unit for a vehicle comprising such a component. The objectives underlying the invention are solved by the features of the independent claims.

### SUMMARY

In one aspect, a method for producing a component of a lighting unit for a vehicle is disclosed. A metallized plastic waveguide antenna element for a radar sensor of the vehicle is integrated into the component. The method comprises providing the component of the lighting unit made from plastic. A portion of the metallized plastic waveguide antenna element is provided. The providing of the portion of the metallized plastic waveguide antenna element comprises metallizing a portion of a frontside of the component, which comprises the portion of the metallized plastic waveguide antenna element as an integral part.

Thereby, a radar waveguide structure may be arranged inside an existing component in form of a plastic part of a lighting unit, like a headlamp. The component may, e.g., be a housing component of the lighting unit. For example, the component may be component of the light unit already intended for metallization, like a reflector of a decorative bezel. In this case, the metallizing of the portion of the frontside of the component may be part of a metallization applied also to other sections of the component.

The metallized plastic waveguide antenna element of the radar sensor is not just placed within the lighting unit, but rather integrated as an integral part of the lighting unit, e.g., a housing of the lighting unit. This may enable a saving of space required for arranging the antenna element within the lighting unit and costs for producing the component of the lighting unit as well as the metallized plastic waveguide antenna element for a radar sensor.

Such a radar sensor for a vehicle, i.e., an automotive radar sensor, may e.g., provide functions such as a lane change assist or a blind spot detection. Lighting units of vehicles, like headlamps and taillamps, are typically arranged at corners of the vehicles. These positions at corners of the vehicles may, e.g., be beneficial for the aforementioned functions of an automotive radar sensor. Therefore, it may be advantageous to integrate metallized plastic waveguide antenna elements into the lighting units of a vehicle, e.g., headlamps and taillamps.

Integrating the metallized plastic waveguide antenna elements into the lighting units may further be beneficial, since the cover material of lamps, like headlamps and taillamps, i.e., the lenses, may be more transparent for electromagnetic waves than other materials of a vehicle, behind which metallized plastic waveguide antenna elements could be arranged, like bumper material.

The waveguide structures may be integrated directly as a part of a component, i.e., a structure of the lighting unit. For example, a plastic part, i.e., a section of a component of a lighting unit is metallized and waveguides arranged therein, which are fed from a corresponding radar electronic component, like an RF chip, which may, e.g., be part of a dedicated radar PCB or even part of the lighting unit as well. A radar electronic component for feeding the waveguide antenna may, e.g., comprise a printed circuit board (PCB), a radio frequency integrated circuit (RFIC) and/or a system-on-a-chip (SOC). No separate radar device may be required. The waveguide structures may rather become an integral part of a plastic part of the lighting unit. Thus, an impact on the lighting unit design, when integrating the waveguide antenna element, may be minimized. For example, a given design of a lighting unit may be basically maintained and only a section of a component of the lighting unit for integrating the waveguide antenna element selected. The selected section may be metallized and provided with radiation apertures. Other structures required for implementing the waveguide antenna element may be added, e.g., on the backside of the respective component.

The metallized plastic waveguide antenna element may, e.g., consist of one part, i.e., be provided in form of a single layer structure. Single layer structure refers to one portion or layer of metallized plastic. It may be provided as a one-piece integral part in form of the component comprising the portion provided by metallizing the portion of the frontside of the component. Thus, the component of the lighting unit comprising the one-piece integral part may be a one-piece part es well. The one-piece integral part may, e.g., enclose an interior space of the waveguide antenna element forming a waveguide structure.

Alternatively, the metallized plastic waveguide antenna element may, e.g., be provided in form of a multi-layer structure. Multi-layer structure refers to a plurality of portions or layers of metallized plastic bonded to each other. The multi-layer structure may, e.g., comprise two or more layers. For example, the multi-layer structure may comprise a metallized plastic front portion or front layer, e.g., provided by the metallizing portion of the frontside of the component of the lighting unit, and a metallized plastic back portion or back layer of the metallized plastic waveguide antenna element. This back portion may be arranged at a backside of the component behind the front portion of the metallized plastic waveguide antenna. For example, the multi-layer structure may only comprise the front portion and the back portion enclosing the interior space of the waveguide antenna element forming the waveguide structure.

Optionally one or more metallized plastic middle portions or middle layers may be arranged between the front portion and back portion. The multi-layer structure with the middle portions may enclose the interior space of the waveguide antenna element forming the waveguide structure.

For example, the waveguide antenna element integrated into the component of the light unit may be configured to be used in a radar sensor of a vehicle. For example, the waveguide antenna element may be configured to be used in a vehicle for mid- to long-range radar applications, e.g., for a front, back and/or corner radar that may be employed for adaptive cruise control (ACC) or parking assistance purposes. The waveguide antenna element may, e.g., be configured to be used for near range radar applications e.g., blind spot detection, curbstone detection in parking assistance, or obstacle detection, pedestrian and/or cyclist detection for door opening warning.

For example, the providing of the component of the lighting unit comprises producing the component. The produced component comprises an integral plastic part to be metallized, in order to provide the portion of the metallized plastic waveguide antenna element.

For example, the component is produced using one of the following production methods: injection molding, 3D printing, machining.

For example, the metallized portion of the frontside of the component forms a light reflector of the lighting unit. A light reflector already requires a reflecting, e.g., metallized surface. Thus, a front portion of the metallized plastic waveguide antenna element may be provided by a metallized light reflector, which may only have to be provided with radiation aperture in addition to the metallization already required for producing the light reflector itself.

For example, the metallized portion of the frontside of the component forms a decorative element of the lighting unit, e.g., a bezel with comprising one or more sections already intended for metallization based on decorative design requirements. Thus, the decorative metallization may be provided with a technical function by using the metallized portion as the front portion of the waveguide antenna element.

For example, the metallized plastic waveguide antenna element is provided as a one-piece integral part in form of the component comprising the portion provided in form of the metallized portion of the frontside of the component. The one-piece integral part comprises an interior space forming a waveguide structure of the metallized plastic waveguide antenna element. The component may comprise the plastic waveguide antenna element as an integral plastic structure manufactured as a part of the component, when manufacturing the component. In addition to the portion of the frontside of the component, e.g., also the interior space enclosed by one-piece integral part, which forms the waveguide structure, may be metallized, in order to provide the metallized plastic waveguide antenna element.

For example, the metallized plastic waveguide antenna element is provided as a multi-layer structure comprising two or more layers. The integral portion of the component forms a first layer of the multi-layer structure. The method further comprises adding one or more additional metallized plastic layers of the multi-layer structure of the metallized plastic waveguide antenna element to the component with the integral portion of the metallized plastic waveguide antenna element. The multi-layer structure of the metallized plastic waveguide antenna element encloses the interior space of the waveguide antenna element forming the waveguide structure.

The one or more additional metallized plastic layers of the multi-layer structure of the metallized plastic waveguide antenna element may be bonded to the component in the form of metallized plastic layers. The one or more additional metallized plastic layers of the multi-layer structure of the metallized plastic waveguide antenna element may be bonded to the component in the form of plastic layers and metallized after the bonding.

For example, the metallized plastic waveguide antenna element is provided as a multi-layer structure comprising two layers. A first layer may be provided by the integral portion of the component as a metallized plastic front portion. A second layer may be provided in form of a metallized plastic back portion. The metallized plastic back portion of the metallized plastic waveguide antenna element may be added to a backside of the component behind the front portion of the metallized plastic waveguide antenna element. The front portion and back portion of the metallized plastic waveguide antenna element may enclose the interior space of the waveguide antenna element forming the waveguide structure.

For example, the one or more additional metallized plastic layers of the multi-layer structure of the metallized plastic waveguide antenna element, e.g., a metallized plastic back portion, are added to the component using a material bonding. A material bonding may enable a fixed bonding, while using two parts for producing the antenna element may facilitate the production and/or metallization of inner waveguiding structures of the waveguide antenna element. The metallized plastic layers may, e.g., be metallized before or after bonding. For example, the layers may be metallized and bonded to the component after the metallization or the layer may be bonded to the component in form of plastic layers, which are metallized after the bonding.

For example, the material bonding is one of the following: an adhesive bonding, a soldered bonding.

For example, the method further comprises producing the one or more additional metallized plastic layers of the multi-layer structure of the metallized plastic waveguide antenna element, e.g., a metallized plastic back portion. The producing of the one or more additional metallized plastic layers may, e.g., comprises producing the respective plastic layers, e.g., a plastic back portion, and metallizing the resulting plastic layers, e.g., the plastic back portion, at least partially. The metallization may be executed before or after bonding the produced plastic layers to the component. For example, the plastic back portion is produced using one of the following production methods: injection molding, 3D printing, machining.

For example, the method further comprises generating a plurality of radiation apertures for radar radiation within the integral part of the component. For example, the radiation apertures are implemented during the production of the component. For example, the radiation apertures are generated after the production of the component using a material removing method.

For example, the component is a bezel of the lighting unit. Thus, the bezel, which may already be intended to be arranged within the lighting unit, e.g., for covering electronic components of the lighting unit may be modified, in order to integrate a waveguide antenna element.

For example, a radome of the radar sensor is provided by a lens of the lighting unit. The lens may provide a high degree of transparency for electromagnetic waves and thus also for the radar waves of the radar sensor.

For example, the lighting unit is a headlamp for the vehicle. For example, the lighting unit is a taillamp for the vehicle.

In another aspect, a component for a lighting unit of a vehicle with a metallized plastic waveguide antenna element for a radar sensor of the vehicle integrated into the component is disclosed.

A component for a lighting unit of a vehicle with a metallized plastic waveguide antenna element for a radar sensor of the vehicle integrated into the component. The component is made of plastic with a portion of a frontside of the component comprising a metallized portion of the metallized plastic waveguide antenna element as an integral part.

For example, the metallized plastic waveguide antenna element is a one-piece integral part of the component comprising the portion provided in form of the metallized portion of the frontside of the component. The one-piece integral part comprises an interior space forming a waveguide structure of the metallized plastic waveguide antenna element.

For example, the metallized plastic waveguide antenna element is a multi-layer structure comprising two or more layers. The integral portion of the component forms a first layer of the multi-layer structure. One or more additional metallized plastic layers of the multi-layer structure of the metallized plastic waveguide antenna element are added to the component with the integral portion of the metallized plastic waveguide antenna element. The multi-layer structure of the metallized plastic waveguide antenna element encloses the interior space of the waveguide antenna element forming the waveguide structure.

For example, the metallized plastic waveguide antenna element is provided as a multi-layer structure comprising two layers. A first layer may be provided by the integral portion of the component as a metallized plastic front portion. A second layer may be provided in form of a metallized plastic back portion. The metallized plastic back portion of the metallized plastic waveguide antenna element may be added to a backside of the component behind the front portion of the metallized plastic waveguide antenna element. The front portion and back portion of the metallized plastic waveguide antenna element may enclose the interior space of the waveguide antenna element forming the waveguide structure.

In another aspect, a lighting unit for a vehicle comprising a component is disclosed. The component is a component for a lighting unit of a vehicle with a metallized plastic waveguide antenna element for a radar sensor of the vehicle integrated into the component. The component is made of plastic with a portion of a frontside of the component comprising a metallized portion of the metallized plastic waveguide antenna element as an integral part.

For example, the metallized plastic waveguide antenna element is a one-piece integral part of the component comprising the portion provided in form of the metallized portion of the frontside of the component. The one-piece integral part comprises an interior space forming a waveguide structure of the metallized plastic waveguide antenna element.

For example, the metallized plastic waveguide antenna element is a multi-layer structure comprising two or more layers. The integral portion of the component forms a first layer of the multi-layer structure. One or more additional metallized plastic layers of the multi-layer structure of the metallized plastic waveguide antenna element are added to the component with the integral portion of the metallized plastic waveguide antenna element. The multi-layer structure of the metallized plastic waveguide antenna element encloses the interior space of the waveguide antenna element forming the waveguide structure.

For example, the metallized plastic waveguide antenna element is provided as a multi-layer structure comprising two layers. A first layer may be provided by the integral portion of the component as a metallized plastic front portion. A second layer may be provided in form of a metallized plastic back portion. The metallized plastic back portion of the metallized plastic waveguide antenna element may be added to a backside of the component behind the front portion of the metallized plastic waveguide antenna element. The front portion and back portion of the metallized plastic waveguide antenna element may enclose the interior space of the waveguide antenna element forming the waveguide structure.

It is understood that one or more of the aforementioned embodiments may be combined as long as the combined embodiments are not mutually exclusive.

### BRIEF DESCRIPTION OF THE DRAWINGS

In the following, examples are described in greater detail making reference to the drawings in which:

FIG. 1 shows a flowchart illustrating an exemplary method for producing a component of a lighting unit for a vehicle,

FIG. 2 shows a flowchart illustrating an exemplary method for producing a component of a lighting unit for a vehicle,

FIG. 3 shows an exemplary lighting unit for a vehicle comprising an integrated waveguide antenna element,

FIG. 4 shows a front view of an exemplary component of a lighting unit for a vehicle comprising an integrated waveguide antenna element,

FIG. 5 shows a back view of the exemplary component of FIG. 4, and

FIG. 6 shows a detailed view of an internal structure of the exemplary waveguide antenna element comprised by the component of FIG. 4.

### DETAILED DESCRIPTION

In the following, similar elements are denoted by the same reference numerals.

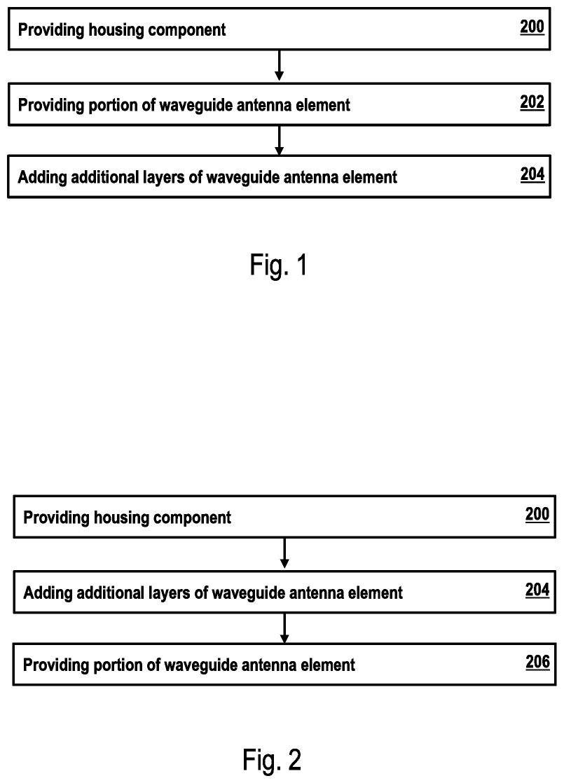

FIG. 1 shows an exemplary method for producing a component of a lighting unit for a vehicle, e.g., a headlamp or a taillamp. When producing the component, a metallized plastic waveguide antenna element for a radar sensor of the vehicle is integrated into the component. In block 200, the component of the lighting unit made from plastic. The component may, e.g., be produced using injection molding, 3D printing, and/or machining. In block 202, a portion of the metallized plastic waveguide antenna element, e.g., a front portion, may be provided. This providing of the portion may comprise metallizing a portion of a frontside of the component comprising the portion of the metallized plastic waveguide antenna element as an integral part. Thus, when producing the component from plastic, the plastic part of the portion of the metallized plastic waveguide antenna element may be produced as an integral part of the component, which is metallized in block 202 proving the metallized portion. The metallized plastic waveguide antenna element may, e.g., be provided as a one-piece integral part in form of the portion provided by metallizing the portion of the frontside of the component. The one-piece integral part comprises an interior space forming a waveguide structure of the metallized plastic waveguide antenna element. Alternatively, the metallized plastic waveguide antenna element may, e.g., be provided as a multi-layer structure comprising two or more layers. The portion of the metallized plastic waveguide antenna element provided by metallizing the portion of the frontside of the component in block 202 may form a first layer of the multi-layer structure.

In optional block 204, one or more additional metallized plastic layers of the multi-layer structure of the metallized plastic waveguide antenna element may be added to the component with the integral portion of the metallized plastic waveguide antenna element. The multi-layer structure of the metallized plastic waveguide antenna element may enclose the interior space of the waveguide antenna element forming the waveguide structure. The additional metallized plastic layers may, e.g., be provided as pre-fabricated elements. The additional metallized plastic layers may, e.g., be produced from plastic, which is then metallized. For producing the additional metallized plastic layers injection molding, 3D printing, and/or machining may be used. The resulting plastic layers may be metallized providing the additional metallized plastic layers to be added to the component, in order to provide the metallized plastic waveguide antenna element integrated into the produced component of the lighting unit. The additional metallized plastic layers of the metallized plastic waveguide antenna element may be added to the component using a material bonding. For example, the material bonding is one of the following: an adhesive bonding, a soldered bonding.

For example, the metallized plastic waveguide antenna element may be provided as a multi-layer structure comprising two layers. A first layer may be the integral portion of the component, which is metallized in block 202, as a metallized plastic front portion. In optional block 204 a metallized plastic back portion as a second layer of the metallized plastic waveguide antenna element may be added to a backside of the component behind the front portion of the metallized plastic waveguide antenna element provided in block 202. The front portion and back portion of the metallized plastic waveguide antenna element together enclose the interior space of the waveguide antenna element forming the waveguide structure. The metallized plastic back portion may, e.g., be provided as a pre-fabricated element. The metallized plastic back portion may, e.g., be produced from plastic, which is then metallized. For producing the plastic back portion injection molding, 3D printing, and/or machining may be used. The resulting plastic back portion may be metallized providing the metallized plastic back portion to be added to the backside of the component, in order to provide the metallized plastic waveguide antenna element integrated into the produced component of the lighting unit. The metallized plastic back portion of the metallized plastic waveguide antenna element may be added to the backside of the component using a material bonding. For example, the material bonding is one of the following: an adhesive bonding, a soldered bonding.

The method may further comprise generating a plurality of radiation apertures for radar radiation within the integral part of the component. For example, the radiation apertures are implemented during the production of the component in block 200. If using injection molding, the apertures may, e.g., be generated by keeping them free of injection material used for the injection molding. If using 3D printing, the apertures may, e.g., be generated by keeping them free of printing material used for the 3D printing. If using machining, the apertures may, e.g., be generated by removing material from a blank, e.g., by drilling.

For example, the radiation apertures are generated after the production of the component, i.e., directly before or after block 202, using a material removing method, e.g., drilling. Alternatively, the radiation apertures may even be generated after block 206.

FIG. 2 shows a further exemplary method for producing a component of a lighting unit for a vehicle, e.g., a headlamp or a taillamp. When producing the component, a metallized plastic waveguide antenna element for a radar sensor of the vehicle is integrated into the component. In block 200, the component of the lighting unit made from plastic. The component may, e.g., be produced using injection molding, 3D printing, and/or machining.

The metallized plastic waveguide antenna element may, e.g., be provided as a multi-layer structure comprising two or more layers. In optional block 204, one or more additional metallized plastic layers of the multi-layer structure of the metallized plastic waveguide antenna element may be added to the component with the integral portion of the metallized plastic waveguide antenna element. The multi-layer structure of the metallized plastic waveguide antenna element may enclose the interior space of the waveguide antenna element forming the waveguide structure. The additional metallized plastic layers may, e.g., be provided as pre-fabricated elements. The additional metallized plastic layers may, e.g., be produced from plastic, which is then metallized. For producing the additional metallized plastic layers injection molding, 3D printing, and/or machining may be used. The resulting plastic layers may be metallized providing the additional metallized plastic layers to be added to the component, in order to provide the metallized plastic waveguide antenna element integrated into the produced component of the lighting unit. The additional metallized plastic layers of the metallized plastic waveguide antenna element may be added to the component using a material bonding. For example, the material bonding is one of the following: an adhesive bonding, a soldered bonding.

For example, the metallized plastic waveguide antenna element may be provided as a multi-layer structure comprising two layers. A first layer may be comprised as a front portion by the component as an integral part. In optional block 204 a plastic back portion of the waveguide antenna element may added as a second layer to a backside of the component behind a front portion of the waveguide antenna element comprised by the component as an integral part. The front portion and back portion of the waveguide antenna element together enclose an interior space of the waveguide antenna element forming a waveguide structure. The back portion may, e.g., be provided as a pre-fabricated element. The back portion may, e.g., be produced from plastic. For producing the plastic back portion injection molding, 3D printing, and/or machining may be used. The plastic back portion of the waveguide antenna element may be added to the backside of the component using a material bonding. For example, the material bonding is one of the following: an adhesive bonding, a soldered bonding.

In block 206, a metallized portion, e.g., a front portion, of the waveguide antenna element is provided by metallizing the front portion produced in block 200 as an integral part of the component. The metallizing of the front portion may, e.g., comprise metallizing a portion of a frontside of the component produced in block 200 and comprising the front portion as an integral part. Also, further portions of the component and, e.g., one or more additional metallized plastic layers, like a back portion, added to the component may be metallized. Alternative the front portion and/or one or more additional metallized plastic layers, like the back portion, may be metallized before the adding in block 204 and only the portion of the frontside of the component may be metallized in block 206.

The method may further comprise generating a plurality of radiation apertures for radar radiation within the integral part of the component. For example, the radiation apertures are implemented during the production of the component in block 200. If using injection molding, the apertures may, e.g., be generated by keeping them free of injection material used for the injection molding. If using 3D printing, the apertures may, e.g., be generated by keeping them free of printing material used for the 3D printing. If using machining, the apertures may, e.g., be generated by removing material from a blank, e.g., by drilling.

For example, the radiation apertures are generated after the production of the component, i.e., directly before or after block 204, using a material removing method, e.g., drilling. Alternatively, the radiation apertures may even be generated after block 206.

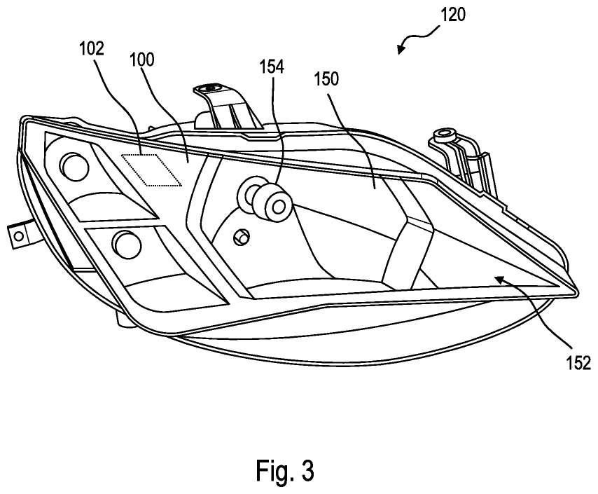

FIG. 3 shows an exemplary lighting unit 120 for a vehicle in form of a headlamp comprising an integrated waveguide antenna element 102 integrated into a component 100, e.g., a bezel of the lighting unit 120. The lighting unit 120 may e.g., further comprise one or more reflectors 150, one or more lamps 154 as well as a lens 152 providing a transparent front portion of the lighting unit 120. Thus, waveguide structures in form of the metallized plastic waveguide antenna element 102 may be integrated into a plastic part of the headlamp, i.e., a plastic component, as an integral part of the respective headlamp plastic part. Thus, an impact of the arranging of the waveguide antenna element 102 within the headlamp on the headlamp design may be minimized.

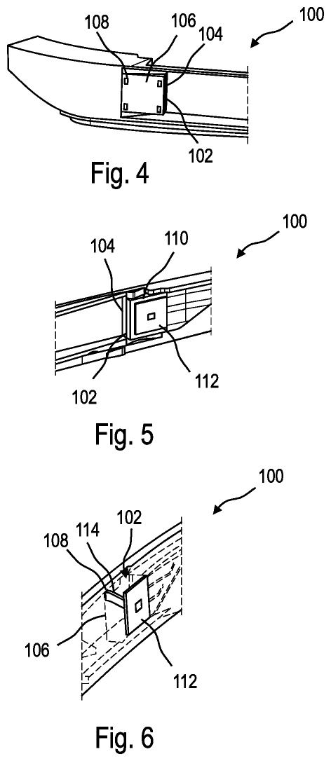

FIG. 4 shows a front view of an exemplary component 100 of a lighting unit for a vehicle comprising an integrated waveguide antenna element 102 in form of a metallized plastic waveguide antenna element. The component 100 is a bezel of the lighting unit 120 comprising a front portion 104 of the waveguide antenna element 102 as an integral part. This front portion 104 comprises a metallized front surface 106 with radiation apertures 108 for radar radiation. In FIG. 4 only four exemplary radiation apertures 108 are shown, but the integrated waveguide antenna element 102 may comprise more.

FIG. 5 shows a back view of the exemplary component 100 of FIG. 4. The metallized plastic waveguide antenna element 102 is provided as a multi-layer structure comprising two layers. A first layer is provided by the front portion 104. A second layer is added in form of a back portion 110 to the front portion 104 of the integrated waveguide antenna element 102, e.g., using an adhesive bonding or a soldered bonding. At a backside of the back portion 110, e.g., within a dedicated reception, a PCB 112 may be arranged. The PCB 112 may generate RF signals to be emitted by the waveguide antenna element 102 and/or process RF signals received by the waveguide antenna element 102. In an alternative example, one or more additional middle layers may be arranged between the front portion 104 and the back portion 110 resulting in a multi-layer structure comprising more than two layers. In an alternative example, the metallized plastic waveguide antenna element may be provided as a one-piece integral part comprising the front portion 104 and the back portion 110 as integral parts.

FIG. 6 shows a detailed view of an internal structure of the exemplary waveguide antenna element 102 integrated into the component 100 of FIG. 4. A waveguide 114 lead from the PCB 112 arranged at the backside of the waveguide antenna element 102 to an aperture 108 arranged within a metallized plastic front surface 106 of the waveguide antenna element 102. Thus, a front portion 104 and a back portion 110 may be integrated inti a lighting unit 100 of a vehicle.

While the invention has been illustrated and described in detail in the drawings and foregoing description, such illustration and description are to be considered illustrative or exemplary and not restrictive; the invention is not limited to the disclosed embodiments.

### REFERENCE SIGNS LIST

100 component
102 integrated waveguide antenna element
104 front portion
106 metallized front surface
108 radiation aperture
110 back portion
112 printed circuit board
114 waveguide
120 lighting unit
150 reflector
152 lens
154 lamp

1. A method for producing a component of a lighting unit for a vehicle, wherein a metallized plastic waveguide antenna element for a radar sensor of the vehicle is integrated into the component, the method comprising:
providing the component of the lighting unit made from plastic; and
providing a portion of the metallized plastic waveguide antenna element, the providing of the portion comprising metallizing a portion of a frontside of the component comprising the portion of the metallized plastic waveguide antenna element as an integral part.

2. The method of claim 1, the providing of the component of the lighting unit comprising producing the component, the produced component comprising the integral plastic part to be metallized in order to provide the portion of the metallized plastic waveguide antenna element.

3. The method of claim 1, wherein the metallized portion of the frontside of the component forms a light reflector of the lighting unit; or
wherein the metallized portion of the frontside of the component forms a decorative element of the lighting unit.

4. The method of claim 1, wherein the metallized plastic waveguide antenna element is provided as a one-piece integral part of the component comprising the portion provided in a form of the metallized portion of the frontside of the component, the one-piece integral part comprising an interior space forming a waveguide structure of the metallized plastic waveguide antenna element.

5. The method of claim 4, wherein the metallized plastic waveguide antenna element is provided as a multi-layer structure comprising two or more layers, the integral portion of the component forming a first layer of the multi-layer structure, the method further comprising:
adding one or more additional metallized plastic layers of the multi-layer structure of the metallized plastic waveguide antenna element to the component with the integral portion of the metallized plastic waveguide antenna element, the multi-layer structure of the metallized plastic waveguide antenna element enclosing the interior space of the waveguide antenna element forming the waveguide structure.

6. The method of claim 5, wherein the one or more additional metallized plastic layers of the multi-layer structure of the metallized plastic waveguide antenna element (102) is added to the component using a material bonding.

7. The method of claim 1, further comprising generating a plurality of radiation apertures for radar radiation within the integral part of the component.

8. The method of claim 1, wherein the component is a bezel of the lighting unit.

9. The method of claim 1 wherein the lighting unit is a headlamp or a taillamp for the vehicle.

10. A component for a lighting unit of a vehicle with a metallized plastic waveguide antenna element for a radar sensor of the vehicle integrated into the component, the component being made of plastic with a portion of a frontside of the component comprising a metallized portion of the metallized plastic waveguide antenna element as an integral part.

11. A lighting unit for a vehicle comprising the component of claim 10.
